(19) United States
(12) Patent Application Publication
(10) Pub. No.: US 2015/0302892 A1
(43) Pub. Date: Oct. 22, 2015

(54) A SHARED AUDIO SCENE APPARATUS

(71) Applicant: NOKIA TECHNOLOGIES OY, Espoo (FI)

(72) Inventor: Juha Petteri OJANPERA, NOKIA (FI)

(21) Appl. No.: 14/646,563

(22) PCT Filed: Nov. 27, 2012
(86) PCT No.: PCT/IB2012/056765

§ 371 Date: May 21, 2015

(51) Int. Cl. G11B 27/031; H04H 60/58; G11B 27/022; G11B 27/10

(52) U.S. Cl. CPC G11B 27/031; G11B 27/10; H04H 60/58; G11B 27/022

(57) ABSTRACT

An apparatus comprising: an input configured to receive an audio signal; a pairwise selector configured to pairwise select the audio signal and a further audio signal, the further audio signal being a verified audio signal; an offset determiner configured to determine an audio signal time offset between the audio signal and the further audio signal; a similarity predictor configured to generate a similarity index based on the time offset applied to one of the audio signal and the further audio signal when compared against the other of the audio signal and the further audio signal; a verifier configured to verify the audio signal time offset based on the similarity index; and a common time line controller configured to generate a common time line incorporating the audio signal.

### FIELD

The present application relates to apparatus for the processing of audio and additionally audio-video signals to enable sharing of audio scene captured audio signals. The invention further relates to, but is not limited to, apparatus for processing audio and additionally audio-video signals to enable sharing of audio scene captured audio signals from mobile devices.

### BACKGROUND

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

### SUMMARY

Aspects of this application thus provide a shared audio capture for audio signals from the same audio scene whereby multiple devices or apparatus can record and combine the audio signals to permit a better audio listening experience.

There is provided according to a first aspect an apparatus comprising at least one processor and at least one memory including computer code for one or more programs, the at least one memory and the computer code configured to with the at least one processor cause the apparatus to at least perform: receive an audio signal; pairwise select the audio signal and a further audio signal, the further audio signal being a verified audio signal; determine an audio signal time offset between the audio signal and the further audio signal; generate a similarity index based on the time offset applied to one of the audio signal and the further audio signal when compared against the other of the audio signal and the further audio signal; verify the audio signal time offset based on the similarity index; and generate a common time line incorporating the audio signal.

Verifying the audio signal time offset based on the similarity index may cause the apparatus to verify only a portion of the audio signal which overlaps with the further audio signal when the time offset is applied to at least one of audio signal and the further audio signal.

Generating a common time line incorporating the audio signal may cause the apparatus to incorporate only a portion of the audio signal which overlaps with the further audio signal when the time offset is applied to at least one of audio signal and the further audio signal.

Generating a similarity index based on the time offset may cause the apparatus to: segment the audio signal into at least two sub-frames; generate for the at least two sub-frames at least two predicted sub-frames based on the sub-frame audio signal and the audio signal time offset; combine the predicted sub-frames; and generate a similarity metric based on the combined predicted sub-frames and the further audio signal.

Segmenting the audio signal into at least two sub-frames may cause the apparatus to segment the audio signal into at least two overlapping sub-frames, and combining the predicted sub-frames may cause the apparatus to overlap-add the predicted sub-frames.

Verifying the audio signal time offset based on the similarity index may cause the apparatus to: compare the similarity metric against a similarity threshold range; and verify at least a portion of the audio signal time offset where the similarity metric for the portion of the audio signal time offset is within the similarity threshold range.

The apparatus may be further caused to: receive a second audio signal; pairwise select the second audio signal and a second further audio signal, the second further audio signal being a verified audio signal; determine a second audio signal time offset between the second audio signal and the second further audio signal; generate a second similarity index based on the second time offset applied to one of the second audio signal and the second further audio signal when compared against the other of the second audio signal and the second further audio signal; and determine that the second audio signal time offset based on the second similarity index is unverified.

The apparatus may be further caused to: determine a further second audio signal time offset between the second audio signal and the second further audio signal; generate a further second similarity index based on the further second time offset applied to one of the second audio signal and the second further audio signal when compared against the other of the second audio signal and the second further audio signal.

The apparatus may be further caused to: determine that the further second audio signal time offset based on the further second similarity index is unverified and further perform: at least one of: repeat the determining of a further audio signal time offset; repeat the pairwise selection; and indicate the second audio signal is unverifiable.

The apparatus may be further caused to: verify the further second audio signal time offset based on the similarity index; and regenerate the common time line incorporating the second audio signal.

According to a second aspect there is provided an apparatus comprising: means for receiving an audio signal; means for pairwise selecting the audio signal and a further audio signal, the further audio signal being a verified audio signal; means for determining an audio signal time offset between the audio signal and the further audio signal; means for generating a similarity index based on the time offset applied to one of the audio signal and the further audio signal when compared against the other of the audio signal and the further audio signal; means for verifying the audio signal time offset based on the similarity index; and means for generating a common time line incorporating the audio signal.

The means for verifying the audio signal time offset based on the similarity index may comprise means for verifying only a portion of the audio signal which overlaps with the further audio signal when the time offset is applied to at least one of audio signal and the further audio signal.

The means for generating a common time line incorporating the audio signal may comprise means for incorporating only a portion of the audio signal which overlaps with the further audio signal when the time offset is applied to at least one of audio signal and the further audio signal.

The means for generating a similarity index based on the time offset may comprise: means for segmenting the audio signal into at least two sub-frames; means for generating for the at least two sub-frames at least two predicted sub-frames based on the sub-frame audio signal and the audio signal time offset; means for combining the predicted sub-frames; and means for generating a similarity metric based on the combined predicted sub-frames and the further audio signal.

The means for segmenting the audio signal into at least two sub-frames may comprise means for segmenting the audio signal into at least two overlapping sub-frames, and the means for combining the predicted sub-frames may comprise means for overlap-adding the predicted sub-frames.

The means for verifying the audio signal time offset based on the similarity index may comprise: means for comparing the similarity metric against a similarity threshold range; and means for verifying at least a portion of the audio signal time offset where the similarity metric for the portion of the audio signal time offset is within the similarity threshold range.

The apparatus may further comprise: means for receiving a second audio signal; means for pairwise selecting the second audio signal and a second further audio signal, the second further audio signal being a verified audio signal; means for determining a second audio signal time offset between the second audio signal and the second further audio signal; means for generating a second similarity index based on the second time offset applied to one of the second audio signal and the second further audio signal when compared against the other of the second audio signal and the second further audio signal; and means for determining that the second audio signal time offset based on the second similarity index is unverified.

The apparatus may further comprise: means for determining a further second audio signal time offset between the second audio signal and the second further audio signal; and means for generating a further second similarity index based on the further second time offset applied to one of the second audio signal and the second further audio signal when compared against the other of the second audio signal and the second further audio signal.

The apparatus may further comprise: means for determining that the further second audio signal time offset based on the further second similarity index is unverified and further comprise at least one of: means for repeating the determining of a further audio signal time offset; means for repeating the pairwise selection; and means for indicating the second audio signal is unverifiable.

The apparatus may further comprise: means for verifying the further second audio signal time offset based on the similarity index; and means for regenerating the common time line incorporating the second audio signal.

According to a third aspect there is provided an apparatus comprising: an input configured to receive an audio signal; a pairwise selector configured to pairwise select the audio signal and a further audio signal, the further audio signal being a verified audio signal; an offset determiner configured to determine an audio signal time offset between the audio signal and the further audio signal; a similarity predictor configured to generate a similarity index based on the time offset applied to one of the audio signal and the further audio signal when compared against the other of the audio signal and the further audio signal; a verifier configured to verify the audio signal time offset based on the similarity index; and a common time line controller configured to generate a common time line incorporating the audio signal.

The verifier may be configured to verify only a portion of the audio signal which overlaps with the further audio signal when the time offset is applied to at least one of audio signal and the further audio signal.

The common time line controller may be configured to incorporate only a portion of the audio signal which overlaps with the further audio signal when the time offset is applied to at least one of audio signal and the further audio signal.

The similarity predictor may comprise: a sub-frame generator configured to segment the audio signal into at least two sub-frames; a predictor configured to generate for the at least two sub-frames at least two predicted sub-frames based on the sub-frame audio signal and the audio signal time offset; a combiner configured to combine the predicted sub-frames; and a similarity ratio determiner configured to generate a similarity metric based on the combined predicted sub-frames and the further audio signal.

The sub-frame generator may be configured to segment the audio signal into at least two overlapping sub-frames, and the combiner may comprise an overlap-adder configured to overlap-add the predicted sub-frames.

The verifier may comprise: a comparator configured to compare the similarity metric against a similarity threshold range; and a portion verifier configured to verify at least a portion of the audio signal time offset where the similarity metric for the portion of the audio signal time offset is within the similarity threshold range.

The input may be configured to receive a second audio signal.

The pairwise selector may be configured to pairwise select the second audio signal and a second further audio signal, the second further audio signal being a verified audio signal.

The offset determiner may be configured to determine a second audio signal time offset between the second audio signal and the second further audio signal.

The similarity ratio determiner may be configured to generate a second similarity index based on the second time offset applied to one of the second audio signal and the second further audio signal when compared against the other of the second audio signal and the second further audio signal.

The verifier may be configured to determine that the second audio signal time offset based on the second similarity index is unverified.

The offset determiner may be configured to determine a further second audio signal time offset between the second audio signal and the second further audio signal; and the similarity radio determiner may be configured to generate a further second similarity index based on the further second time offset applied to one of the second audio signal and the second further audio signal when compared against the other of the second audio signal and the second further audio signal.

The verifier may be configured to determine that the further second audio signal time offset based on the further second similarity index is unverified.

The apparatus may comprise a controller configured to control at least one of: repeating the determining of a further audio signal time offset; repeating the pairwise selection; and indicating the second audio signal is unverifiable.

The apparatus may further comprise: the verifier configured to verify the further second audio signal time offset based on the similarity index; and the timeline controller configured to regenerate the common time line incorporating the second audio signal.

According to a fourth aspect there is provided a method comprising: receiving an audio signal; pairwise selecting the audio signal and a further audio signal, the further audio signal being a verified audio signal; determining an audio signal time offset between the audio signal and the further audio signal; generating a similarity index based on the time offset applied to one of the audio signal and the further audio signal when compared against the other of the audio signal and the further audio signal; verifying the audio signal time offset based on the similarity index; and generating a common time line incorporating the audio signal.

Verifying the audio signal time offset based on the similarity index may comprise verifying only a portion of the audio signal which overlaps with the further audio signal when the time offset is applied to at least one of audio signal and the further audio signal.

Generating a common time line incorporating the audio signal may comprise incorporating only a portion of the audio signal which overlaps with the further audio signal when the time offset is applied to at least one of audio signal and the further audio signal.

Generating a similarity index based on the time offset may comprise: segmenting the audio signal into at least two sub-frames; generating for the at least two sub-frames at least two predicted sub-frames based on the sub-frame audio signal and the audio signal time offset; combining the predicted sub-frames; and generating a similarity metric based on the combined predicted sub-frames and the further audio signal.

Segmenting the audio signal into at least two sub-frames may comprise segmenting the audio signal into at least two overlapping sub-frames, and combining the predicted sub-frames may comprise overlap-adding the predicted sub-frames.

Verifying the audio signal time offset based on the similarity index may comprise: comparing the similarity metric against a similarity threshold range; and verifying at least a portion of the audio signal time offset where the similarity metric for the portion of the audio signal time offset is within the similarity threshold range.

The method may further comprise: receiving a second audio signal; pairwise selecting the second audio signal and a second further audio signal, the second further audio signal being a verified audio signal; determining a second audio signal time offset between the second audio signal and the second further audio signal; generating a second similarity index based on the second time offset applied to one of the second audio signal and the second further audio signal when compared against the other of the second audio signal and the second further audio signal; and determining that the second audio signal time offset based on the second similarity index is unverified.

The method may further comprise: determining a further second audio signal time offset between the second audio signal and the second further audio signal; and generating a further second similarity index based on the further second time offset applied to one of the second audio signal and the second further audio signal when compared against the other of the second audio signal and the second further audio signal.

The method may further comprise: determining that the further second audio signal time offset based on the further second similarity index is unverified and further comprise at least one of: repeating the determining of a further audio signal time offset; repeating the pairwise selection; and indicating the second audio signal is unverifiable.

The method may further comprise: verifying the further second audio signal time offset based on the similarity index; and regenerating the common time line incorporating the second audio signal.

A computer program product stored on a media may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For better understanding of the present application, reference now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an example content co-ordinating apparatus according to some embodiments;

FIG. 4 shows a flow diagram of the operation of the example content co-ordinating apparatus shown in FIG. 3 according to some embodiments;

FIG. 5 shows schematically an example similarity predictor apparatus as shown in FIG. 3 according to some embodiments;

FIG. 6 shows a flow diagram of the operation of the example similarity predictor apparatus as shown in FIG. 5 and the operation of the verifier apparatus shown in FIG. 3 according to some embodiments; and

FIG. 7 shows audio alignment examples according to some embodiments.

### EMBODIMENTS OF THE APPLICATION

The following describes in further detail suitable apparatus and possible mechanism for the provision of effective audio signal capture sharing. In the following examples, audio signals and audio capture signals are described. However it would be appreciated that in some embodiments the audio signal/audio capture is a part of an audio-video system.

The concept of this application is related to assisting in the production of immersive person-to-person communication and can include video. It would be understood that the space within which the devices record the audio signal can be arbitrarily positioned within an event space. The captured signals as described herein are transmitted or alternatively stored for later consumption where the end user can select the listening point based on their preference from the reconstructed audio space. The rendering part then can provide one or more down mixed signals from which the multiple recordings that correspond to the selective listening point. It would be understood that each recording device can record the event seen and upload or upstream the recorded content. The uploaded or upstream process can include implicitly positioning information about where the content is being recorded,

Furthermore an audio scene can be defined as a region or area within which a device or recording apparatus effectively captures the same audio signal. Recording apparatus operating within an audio scene and forwarding the captured or recorded audio signals or content to a co-ordinating or management apparatus effectively transmit many copies of the same or very similar audio signal. The redundancy of many devices capturing the same audio signal permits the effective sharing of the audio recording or capture operation.

Before it is possible to use the multi-user recorded content for various content processing methods, such as audio mixing from multiple users and video view switching from one user to the other, the content between different users must by synchronised such that they employ a common timeline or timestamp. The local device or apparatus clocks of the content from different user apparatus is required to be at least within few tens of milliseconds of each other before content from multiple user devices can be jointly processed. For example where the clocks of different user devices (and, hence, the timestamp of the creation time of the content itself) are not in synchronization then any attempt at content processing can fail (as the content processing produces poor quality signal/content) for the multi-user device recorded content.

Furthermore, the audio scene recorded by neighbouring devices is typically not the same signal. For example the various devices or apparatus physically within the same area can record the audio scene with varying quality depending on various recording issues. These recording issues can include the position of the user device in the audio scene. For example the closer the device is to the actual sound source typically the better the quality of the recording. Furthermore another issue is the surrounding ambient noise. For example crowd noise from nearby locations can negatively impact on the recording of the audio scene source. Another recording quality variable is the recording characteristics of the device. For example the quality of the microphone(s), the quality of the analogue to digital converted, and the encoder and compression used to encode the audio signal prior to transmission or storage.

Synchronization can for example be achieved using dedicated synchronization signals to time stamp the recordings. The synchronization signal can be some special beacon signal or timing information, for example the clock signal obtained through GPS satellite transmissions or cellular network time clocks. However the use of a beacon signal typically requires special hardware and/or software installations which limit the applicability to multi-user device sharing services. For example recording devices become too expensive for mass use, use significant battery and processing power in receiving and determining the synchronisation signals and further limits the use of existing devices for these multi-user device services (in other words older devices or low specification devices cannot use such services).

Furthermore it is known that whilst synchronization signals such as GPS signals can be used and the limitation of such signals are also known, for example they can be received only with a GPS receiver and can fail in built up areas, valleys or forested regions outdoors and indoors where the signal is not received.

Ad-hoc or non-beacon methods have been proposed for synchronisation purposes. However these methods typically do not perform well in the multi-device environment since as the number of recordings increase so does the amount of correlation calculations. Furthermore the processing or correlation calculation increase is exponential rather than linear as the number of recordings increase so requiring significant processing capacity increases as the number of recordings increase. Furthermore in the methods described in the art the time skew between multiple content recordings typically needs to be limited to tens of seconds at maximum; otherwise the computational complexity and processing requirements become overwhelming.

Added to the processing requirement issues with the synchronisation methods described in the art, the differences in the audio scene characteristics described herein impact significantly on the overall robustness of the prior art synchronisation methods. For example a signal can be aligned to the common timeline but at wrong time position or aligned even when the signal is actually not part of the common timeline at all. In such situations any subsequent content processing methods can fail or produce significantly poorer resultant output audio signals.

The purpose of the embodiments described herein is therefore to provide an apparatus which can create a common timeline, or synchronize the audio signals, from the multi-user recorded content which is robust to various deficiencies in the recorded audio scene signal.

The embodiments can be summarised furthermore as a method for organizing audio scenes from multiple devices or apparatus into common timeline. The embodiments as described herein add significant robustness to the accuracy of the timeline by cascading alignment methods and a prediction based similarity verification. The embodiments as described herein can be summarised as the following operations or steps:

Selecting signal pairs;

Determining time offset for signal pairs;

Windowing and predicting aligned samples from the signal pair;

Verifying similarity of the aligned and predicted samples;

Adding or rejecting the signal pair from common timeline.

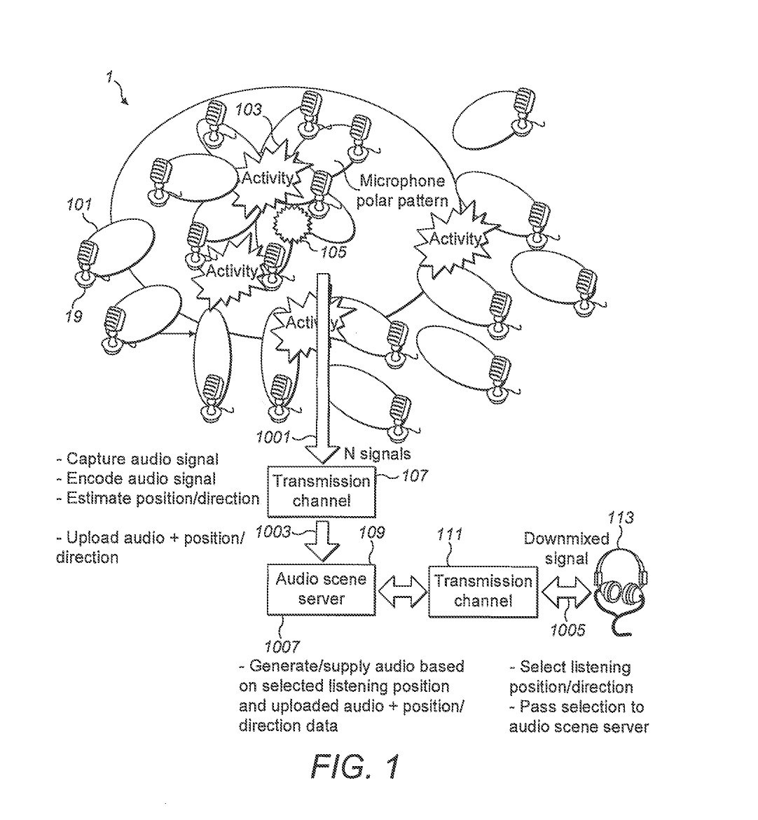

With respect to FIG. 1 an overview of a suitable system within which embodiments of the application can be located is shown. The audio space 1 can have located within it at least one recording or capturing device or apparatus 19 which are arbitrarily positioned within the audio space to record suitable audio scenes. The apparatus 19 shown in FIG. 1 are represented as microphones with a polar gain pattern 101 showing the directional audio capture gain associated with each apparatus. The apparatus 19 in FIG. 1 are shown such that some of the apparatus are capable of attempting to capture the audio scene or activity 103 within the audio space. The activity 103 can be any event the user of the apparatus wishes to capture. For example the event could be a music event or audio of a “news worthy” event. The apparatus 19 although being shown having a directional microphone gain pattern 101 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 107 to an audio scene server 109. The recording apparatus 19 in some embodiments can encode the audio signal to compress the audio signal in a known way in order to reduce the bandwidth required in “uploading” the audio signal to the audio scene server 109.

The recording apparatus 19 in some embodiments can be configured to estimate and upload via the transmission channel 107 to the audio scene server 109 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal. With respect to the application described herein an audio or sound source can be defined as each of the captured or audio recorded signal. In some embodiments each audio source can be defined as having a position or location which can be an absolute or relative value. For example in some embodiments the audio source can be defined as having a position relative to a desired listening location or position. Furthermore in some embodiments the audio source can be defined as having an orientation, for example where the audio source is a beamformed processed combination of multiple microphones in the recording apparatus, or a directional microphone. In some embodiments the orientation may have both a directionality and a range, for example defining the 3dB gain range of a directional microphone.

The capturing and encoding of the audio signal and the estimation of the position/direction of the apparatus is shown in FIG. 1 by step 1001.

The uploading of the audio and position/direction estimate to the audio scene server 109 is shown in FIG. 1 by step 1003.

The audio scene server 109 furthermore can in some embodiments communicate via a further transmission channel 111 to a listening device 113.

In some embodiments the listening device 113, which is represented in FIG. 1 by a set of headphones, can prior to or during downloading via the further transmission channel 111 select a listening point, in other words select a position such as indicated in FIG. 1 by the selected listening point 105. In such embodiments the listening device 113 can communicate via the further transmission channel 111 to the audio scene server 109 the request.

The selection of a listening position by the listening device 113 is shown in FIG. 1 by step 1005.

The audio scene server 109 can as discussed above in some embodiments receive from each of the recording apparatus 19 an approximation or estimation of the location and/or direction of the recording apparatus 19. The audio scene server 109 can in some embodiments from the various captured audio signals from recording apparatus 19 produce a composite audio signal representing the desired listening position and the composite audio signal can be passed via the further transmission channel 111 to the listening device 113.

The generation or supply of a suitable audio signal based on the selected listening position indicator is shown in FIG. 1 by step 1007.

In some embodiments the listening device 113 can request a multiple channel audio signal or a mono-channel audio signal. This request can in some embodiments be received by the audio scene server 109 which can generate the requested multiple channel data.

The audio scene server 109 in some embodiments can receive each uploaded audio signal and can keep track of the positions and the associated direction/orientation associated with each audio source. In some embodiments the audio scene server 109 can provide a high level coordinate system which corresponds to locations where the uploaded/upstreamed content source is available to the listening device 113. The “high level” coordinates can be provided for example as a map to the listening device 113 for selection of the listening position. The listening device (end user or an application used by the end user) can in such embodiments be responsible for determining or selecting the listening position and sending this information to the audio scene server 109.

The audio scene server 109 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 109 can provide in some embodiments a selected set of downmixed signals which correspond to listening points neighbouring the desired location/direction and the listening device 113 selects the audio signal desired.

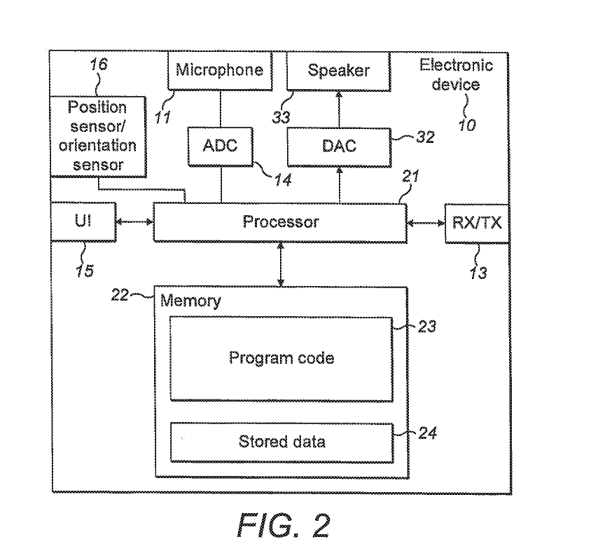

In this regard reference is first made to FIG. 2 which shows a schematic block diagram of an exemplary apparatus or electronic device 10, which may be used to record (or operate as a recording or capturing apparatus 19) or listen (or operate as a listening apparatus 113) to the audio signals (and similarly to record or view the audio-visual images and data). Furthermore in some embodiments the apparatus or electronic device can function as the audio scene server 109.

The electronic device 10 may for example be a mobile terminal or user equipment of a wireless communication system when functioning as the recording device or listening device 113. In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio signal or content shot detection routines.

in some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 107 (where the apparatus is functioning as the recording device 19 or audio scene server 109) or further transmission channel 111 (where the device is functioning as the listening device 113 or audio scene server 109). The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 109. In some further embodiments the audio scene server 109 can comprise a processor, memory and transceiver combination.

In the following examples there are described an audio scene/content recording or capturing apparatus which correspond to the recording device 19 and an audio scene/content co-ordinating or management apparatus which corresponds to the audio scene server 109. However it would be understood that in some embodiments the audio scene management apparatus can be located within the recording or capture apparatus as described herein and similarly the audio scene recording or content capture apparatus can be a part of an audio scene server 109 capturing audio signals either locally or via a wireless microphone coupling,

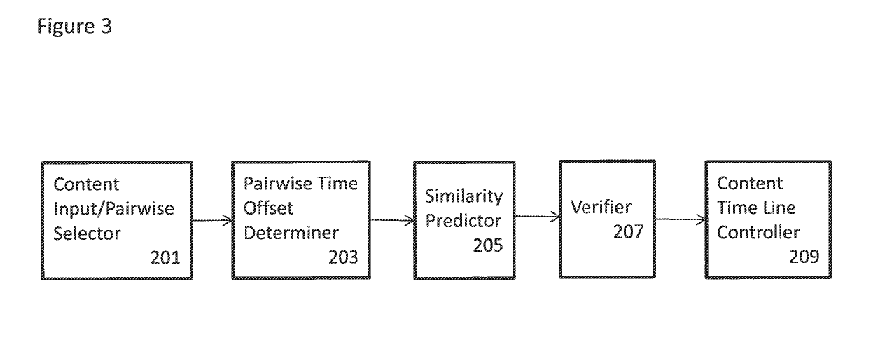

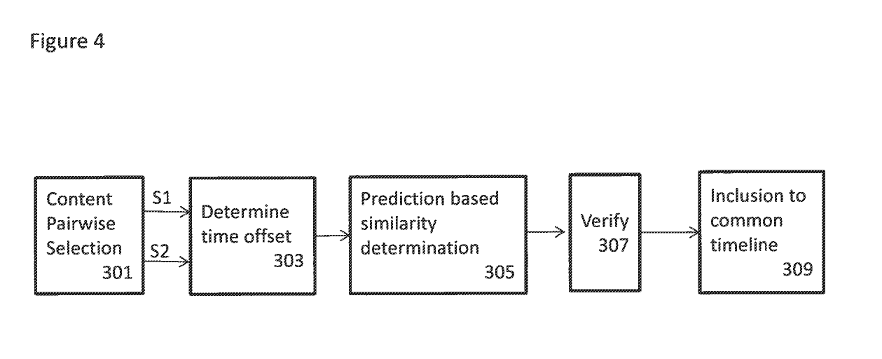

With respect to FIG. 3 an example content co-ordinating apparatus according to some embodiments is shown which can be implemented within the recording device 19, the audio scene server, or the listening device (when acting as a content aggregator). Furthermore FIG. 4 shows a flow diagram of the operation of the example content co-ordinating apparatus shown in FIG. 3 according to some embodiments.

In some embodiments the content input 201. The content input 201 can in some embodiments be the microphone input, or a received input via the transceiver or other wire or wireless coupling to the apparatus. In some embodiments the content input 201 is the memory 22 and in particular the stored data memory 24 where any edited or unedited audio signal is stored,

Furthermore the content input 201 can be configured to perform a pairwise operation where in a pair of the input audio signals or content are selected to start or continue the operation of producing a common timeline for all of the content or audio signals. In some embodiments at least one of the pair has previously been selected for a previous pairwise timeline insertion operation and thus is already synchronised with respect to a common timeline. In some embodiments where there is no common timeline previously established with respect to the content or audio signals then the content input 201 can be configured to select at least one of the audio signals or content as a reference timeline.

The operation of pairwise selecting the audio inputs is shown in FIG. 4 by step 301.

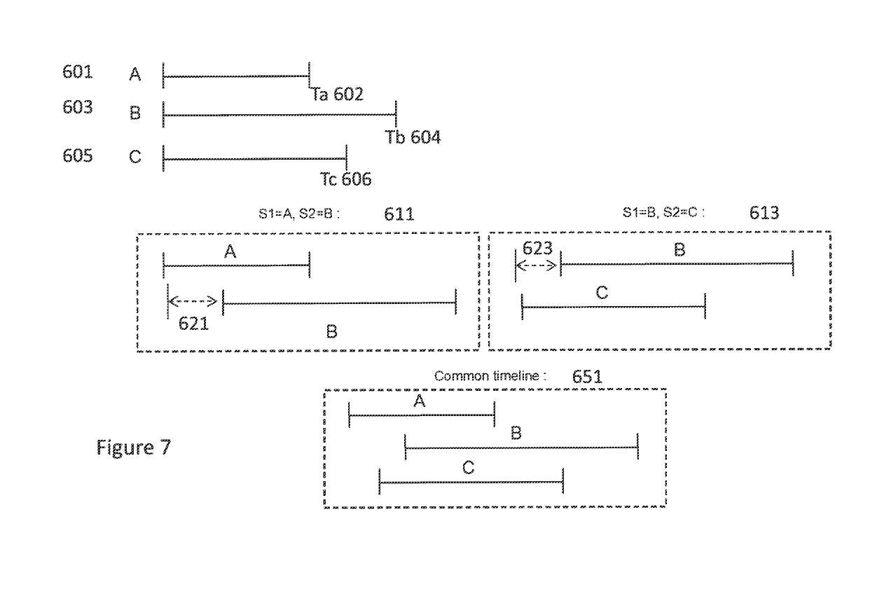

With respect to FIG. 7 an example set of input content or audio signals is shown. In the example shown, the content input comprises three audio signals, a first audio signal A 601 having a first length Tₐ 602, a second audio signal B 603 having a second length T_{b} 604, and a third audio signal C 605 having a third length T_{c} 606. In the example shown the pairwise selector 201 generates a first pairwise selection 611 where audio signal A 601 is designated audio signal input S1, and audio signal B 603 is designated audio signal input S2.

In some embodiments the content coordinating apparatus comprises a pairwise time offset determiner 203. The pairwise time offset determiner 203 can in some embodiments receive the selected audio input signal pair (content pair) and be configured to synchronise or determine a time delay between the two audio signals. In other words a signal pair (S1, S2) is first time aligned. The alignment determines the time offset between the signals, that is, the offset the first signal need to be delayed with respect to the second signal or vice versa. In some embodiments the time offset value can be determined by any suitable manner, for example correlation, convolution, or any known time offset method. The time offset value can in some embodiments be passed to the similarity predictor 203.

The operation of initially determining a e offset value between the two audio signals is shown in FIG. 4 by step 303.

In the example shown in FIG. 7 the first pairwise selection 611 (S1=A,S2=B) time offset DAB 621 is determined.

In some embodiments the content coordinating apparatus comprises a similarity predictor 205. The similarity predictor 205 can be configured to receive the signal pair and the time offset value and determine a similarity ratio or metric based on the signal pair and the time offset. The concept in embodiments is to obtain a predicted version of the signal with the help of the other signal in the pair and the offset value.

The similarity ratio or metric can in some embodiments be passed to the verifier 207.

The operation of generating a similarity ratio or metric based on the signal pair and the time offset value is shown in FIG. 4 by step 305.

Although as described herein the signal domains for the pairwise time offset determiner 203 and the similarity predictor 205 are time domain operations it would be understood that in some embodiments the signal domains used in the pairwise time offset determiner 203 and the similarity predictor 205 can be different. For example, the signal domain for the pairwise time offset determiner 203 can in some embodiments be a conventional time domain signal and for the similarity predictor 205 the signal domain can in some embodiments be a frequency or feature domain. Similarly in some embodiments the signal domain for the pairwise time offset determiner 203 can be the frequency or feature domain and the similarity predictor 205 the time domain. Or furthermore both the pairwise time offset determiner 203 and the similarity predictor 205 can operates in a frequency or feature domain in some embodiments.

In other words in some embodiments the apparatus can comprise a converter configured to convert a time domain signal to some other representation domain such as Fourier signal, harmonic ratio of the audio signal, low energy ratio or audio beats for the similarity predictor.

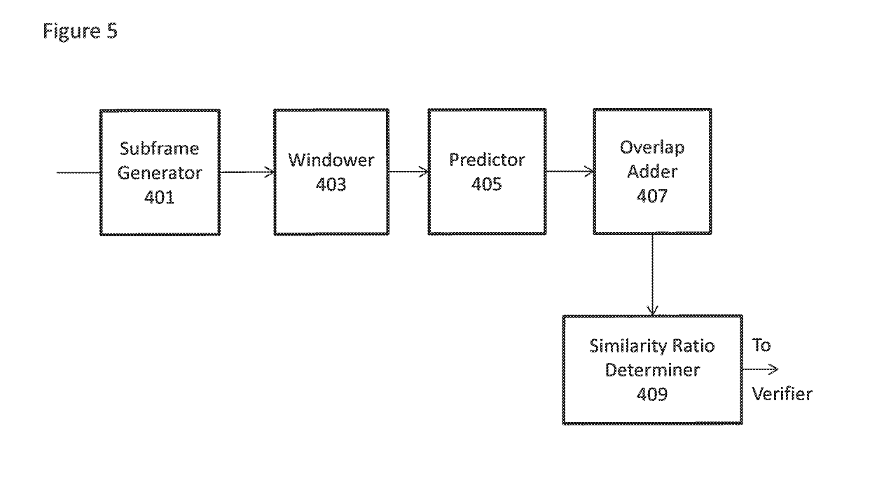

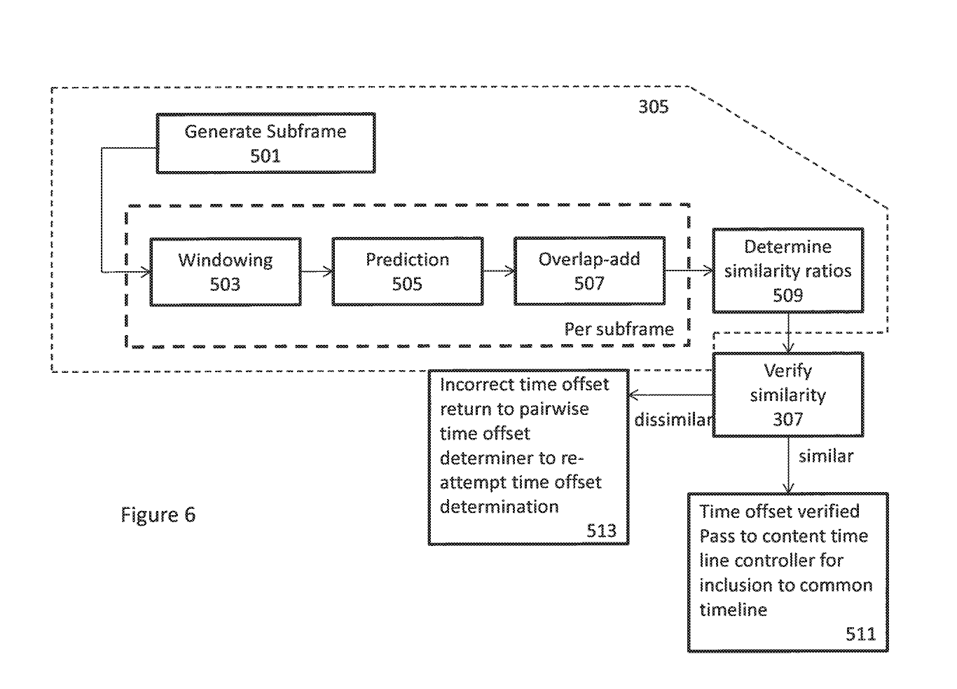

With respect to FIG. 5 an example similarity predictor 205 is shown according to some embodiments, furthermore with respect to FIG. 6 the operation of the example similarity predictor 205 and the verifier is shown.

In some embodiments the similarity predictor 205 comprises a subframe generator 501. The subframe generator 501 in some embodiments is configured to receive the pairwise selected audio signals, and generate an ‘overlapping’ pair of audio signals, for example by selecting subframe inputs where one of the audio signal inputs starts at a time instant within the content input defined by the time offset determined by the pairwise time offset determiner 203. Furthermore the subframe generator 501 in some embodiments is configured to divide the ‘overlapping’ audio signals into suitable sub-frame lengths.

For example as shown with respect to the example in FIG. 7, where the signal pair input (S1=A, S2=B) has a time offset of DAB time units (in other words there is a delay between the earlier A 601 audio signal and the later B 603 audio signal), then the signal pair for the first pairwise selection is processed such that the subframe analysis occurs on the pairwise selection of x=A+DAB and y=B. In other words the samples that cover the non-overlapping period between signals A and B are removed from the later calculations.

Furthermore the number of elements in the pair can be defined as xyLen where xyLen is the minimum of length x and length y. In the example shown in FIG. 7, the value of xyLen is Tₐ−DAB. The subframe calculation is such that the size of the subframe (iSubframe) is typically much smaller than xyLen.

The output of the subframe generator 501 can in some embodiments be passed to the windower 403.

The operation of generating the subframes for the selected pairwise audio signals is shown in FIG. 6 by step 501.

In some embodiments the similarity predictor 205 comprises a windower 403. The windower 403 in some embodiments receives the ‘overlapping’ audio signals from the subframe generator 401 and the length of the subframe interval and generates windowed subframe audio signals from the ‘overlapping’ audio signals.

The x and y signals, the ‘overlapping’ audio signals for example are first windowed according to:

wX(n)=win(n)·x(n+l·T),

wY(n)=win(n)·y(n+l·T) 0≦n <iSubframe,

where win( ) is a prediction analysis window, iSubframe is the size of the subframe, I is the subframe index, and T is the hop size between successive subframes. In some embodiments the prediction analysis window can be any type of window, for example sinusoidal, Hanning, Hamming, Welch, Bartlett, Kaiser or Kaiser-Bessel Derived (KBD) window. In some embodiment to obtain continuity and smooth prediction signal over subframes, the hop size is set to T=iSubframe/2, that is, the previous and current signal segments are 50% overlapping. It would be understood that in some embodiments other overlapping ratios are also implemented.

The output of the windower 403 can in some embodiments be passed to the predictor 405.

The operation of windowing the ‘overlapping’ audio signals is shown in FIG. 6 by step 503.

In some embodiments the similarity predictor 205 comprises a predictor 405. The predictor 405 is configured to receive the windowed subframes of the audio signals and generated a predicted signal for a least one of the audio signals. For example in some embodiments the signal x is predicted using the (x,y) data pair. The predictor goal is to obtain a predicted signal corresponding to x using signal y as input. For example, the predictor can in some embodiments generate a predicted signal by applying a filter which has a transfer function according to:

$$B ( z ) = {\sum }_{k = 0}^{P} {a}_{k} {z}^{- k} ,$$

where aₖ are filter coefficients and P+1 is the filter order. The filter coefficients can in some embodiments be determined by minimizing the mean squared error function defined by

$$E = {\sum }_{i = 0}^{iSubframe - 1} {[ wX ( i ) - {\sum }_{k = 0}^{P} a ( k ) \cdot wY ( i + k ) ]}^{2} .$$

In such embodiments setting ∂E/∂b=0 leads to a set of j×j(j=P+1) linear equations

$$E = {\sum }_{i = 0}^{iSubframe - 1} {wX ( i )}^{2} - 2 \cdot {\sum }_{i = 0}^{iSubframe - 1} wX ( i ) \cdot {\sum }_{k = 0}^{P} a ( k ) \cdot wY ( i + k ) + {\sum }_{i = 0}^{iSubframe - 1} {( {\sum }_{k = 0}^{P} a ( k ) \cdot wY ( i + k ) )}^{2}$$

$$\frac{\partial E}{\partial b} = - 2 \cdot {\sum }_{i = 0}^{iSubframe - 1} wX ( i ) \cdot {\sum }_{k = 0}^{P} wY ( i + k ) + 2 \cdot {\sum }_{i = 0}^{iSubframe - 1} [ ( {\sum }_{k = 0}^{P} a ( k ) \cdot wY ( i + k ) ) \cdot {\sum }_{k = 0}^{P} wY ( i + k ) ] = 0$$

$${\sum }_{i = 0}^{iSubframe - 1} [ ( {\sum }_{k = 0}^{P} a ( k ) \cdot wY ( i + k ) ) \cdot {\sum }_{k = 0}^{P} wY ( i + k ) ] = {\sum }_{i = 0}^{iSubframe - 1} wX ( i ) \cdot {\sum }_{k = 0}^{P} wY ( i + k )$$

which can be written in a compact matrix form (Ca=r)

$$[ \begin{matrix}c ( 0 , 0 ) & c ( 0 , 1 ) & … & c ( 0 , P ) \\ c ( 1 , 0 ) & c ( 1 , 1 ) & … & c ( 1 , P ) \\ ⋮ & ⋮ & & ⋮ \\ c ( P , 0 ) & c ( P , 1 ) & … & c ( P , P )\end{matrix} ] \cdot [ \begin{matrix}{a}_{0} \\ {a}_{1} \\ ⋮ \\ {a}_{P}\end{matrix} ] = [ \begin{matrix}r ( 0 ) \\ r ( 1 ) \\ ⋮ \\ r ( P )\end{matrix} ]$$

$$where$$

$$c ( m , n ) = {\sum }_{i = 0}^{iSubframe - 1} wY ( i + m ) \cdot wY ( i + n )$$

$$r ( m ) = {\sum }_{i = 0}^{iSubframe - 1} wX ( i ) \cdot wY ( i + m )$$

The optimum filter coefficients can then be found by a=C⁻¹·r.

Therefore in some embodiments the predictor 405 can obtain the predicted signal \tilde{x}ₗ for the l^{th} subframe index according to:

$${\tilde{x} ( i )}_{l} = {\sum }_{j = 0}^{P} wY ( i + j ) \cdot {\hat{a}}_{k} ( j ) , \\ 0 \leq i < iSubframe .$$

The output of the predictor 405 can in some embodiments be passed to the overlap adder 407. Although the predictor 405 has been shown generating a prediction of x from y it would be understood that the predictor 405 in some embodiments can be configured to generate a prediction of y from x.

The operation of generating a prediction of one of the signals x or y is shown in FIG. 5 by step 505.

In some embodiments the similarity predictor 205 comprises an overlap adder 407. The overlap adder 407 is configured to receive the output of the predictor 405 and overlap-add the predicted signal on a subframe basis. In other words the overlap adder 407 is configured to (re)construct a final predicted signal. The overlap-add operation according to some embodiments can be:

$${\tilde{y}}_{imp} ( n + l \cdot T ) = {\tilde{y}}_{imp} ( n + l \cdot T ) + \tilde{x} ( n ) , \\ 0 \leq n < \frac{iSubframe}{2}$$

$${\tilde{y}}_{imp} ( n + ( l + 1 ) \cdot T ) = \tilde{x} ( \frac{iSubframe}{2} + n ) , \\ 0 \leq n < \frac{iSubframe}{2}$$

It would be understood that the above operations are repeated for 0≦i<L where L is the number of subframes according to l+┌2·xyLen/iSubframe┐+1 and ┌ ┐ rounds up the specified value.

The operation on the overlapping sub-frames produces a final predicted signal used in subsequent similarity processing:

$$\tilde{y} ( n ) = {\tilde{y}}_{imp} ( n + \frac{iSubframe}{2} ) , \\ 0 \leq n < xyLen$$

The output of the overlap adder 407 can in some embodiments be passed to the similarity ratio determiner 409.

The operation of generating an overlapped added predicted signal is shown in FIG. 5 by step 507.

In some embodiments the similarity predictor 205 comprises a similarity ratio determiner 409. The similarity ration determiner 409 is configured to receive the overlapped added predicted signal and generate a similarity ratio to be checked by the verifier 207.

In some embodiments the similarity ratio, a similarity measure between signals x and \tilde{y}, is calculated according to the following pseudo-code:

| | |
|---|---|
| 1 | dfSetItems = 0 |
| 2 | |
| 3 | For k = 0 to xyLen |
| 4 | $dRat = \vert \frac{x ( k )}{\tilde{y} ( k )} \vert$ |
| 5 | If dRat >= 0.85 and dRat <= 1.15 |
| 6 | dfSetItems += 1 |
| 7 | Endif |
| 8 | Endfor |

In other words the similarity predictor 205 can be configured to initialise a set items counter (line 1), initialise a ‘for’ loop to analyse each sample from sample 0 to sample xyLen (the length of the overlapping audio signals) (line 3), generate a absolute ratio or similarity ratio dRat (line 4), test the similarity ratio against a predetermined threshold (one 5)—the determined threshold in this example being 0.85, increment the count dfSetitems where the similarity ratio is within the threshold range (line 6), and then loop the for loop (line 7).

In the example pseudocode implementation shown herein the similarity measure is simply the number of items which are within the specified threshold values. Line 4 calculates the absolute ratio of the signal x and \tilde{y} for every element in the vector, and if the ratio is above 0.85 and below 1.15 (line 5), the variable indicating how many items are within the specified threshold is increased, in line 6.

The similarity predictor 205 can in some embodiments then determine an overall similarity measure by determining the following:

$$sMeasure = \frac{dfSetItems}{xyLen}$$

This sMeasure or similarity measure value then can be output as a similarity determination to the verifier 207.

The operation of determining the similarity values is shown in FIG. 6 by step 509.

It would be understood that the similarity predictor 205 is configured to obtain a representative signal \tilde{y} for the reference signal x using the signal pair (x, y) as an input. However the prediction implementation can be any suitable prediction method such as a backward adaptive prediction, for example: L. Yin, M. Suonio, M. Väänänen, “A new backward predictor for MPEG audio coding”, 103^{rd} AES Convention, New York 1997, Preprint 4521, Furthermore in some embodiments, the representative signal can be derived using multiple methods which are verified either independently or in some embodiments together (for example where any or all or some combination of the prediction methods produce ‘similar’ output then the signal data pair is accepted for inclusion to the common timeline model.

In some embodiments the content coordinating apparatus comprises a verifier 207. The verifier 207 can be configured to receive the similarity ratio or metric and determine whether the time offset value is verified, where the verifier 207 determines the time offset is verified (or not verified) then the verifier can be configured to pass the signal pair and the time offset to a content time line controller 209. In other words the verifier determines using the similarity measure whether the alignment of the pair was successful (or not).

The verifier in some embodiments can verify the time offset value by using the similarity determination or measure according to the following determination:

$$timeOffsetResult = \{ \begin{matrix}similar , & sMeasure > 0.5 \\ dissimilar , & otherwise\end{matrix}$$

In other terms, the signal pair (x, y) is found to be aligned if more than half of the milarity measures, as described by the ratio of the signal x and the predicted version of that \tilde{y}, are within the specified threshold.

It would be understood that in some embodiments the verification determination threshold can be more than or less than 0.5.

The operation of verifying the time offset value based on the similarity ratio or metric is shown in FIG. 4 (and also FIG. 6) by step 307.

Where the verification fails, the similarity measure shows that the values are dissimilar, then the verifier 207 can in some embodiments cause the content input/pairwise selection 201 to choose a further pair to test or pass to the pairwise time offset determiner to generate a further attempt at determining the time offset value of the current pair audio signal selection.

The operation of returning to generate another time offset is shown in FIG. 6 by step 513.

Where the verification is passed, the similarity measure shows that the values are similar, then the verifier 207 can in some embodiments cause the content time line controller 209 to incorporate the time offset into a common timeline model of the content.

The operation of passing the values to the content time line controller for inclusion to the common timeline is shown in FIG. 6 by step 511.

In some embodiments the content coordinating apparatus comprises a content time line controller 209. The content time line controller 209 can be configured to receive the verification of the time offset result and control whether the timelines are to be synchronised on a common time line.

For example with respect to the example shown in FIG. 7, where the time offset between (S1=A, S2=B) DAB is verified then a common timeline 651 model can be generated with audio signal A 601 being verified as starting DAB 621 time units before audio signal B 603.

Furthermore in the same example shown in FIG. 7, when the common timeline 651 model is generated then the operation can return back to the pairwise selection operation 301 where a further pair of signals are chosen. For example as shown in FIG. 7 a second pairwise selection (S1=B, S2=C) 613 is shown, a time offset DCB 623 is determined, a similarity determination using DCB is performed and verified and the common timeline model 651 added to with the audio signal C 605 being located DCB time units earlier than audio signal B 603.

In other words for example where FIG. 7 illustrates the creation of common timeline for 3 signals (labelled as A 601, B 603 and C 605). First, signal pair selection 611 (A, B) is aligned and verified using prediction based similarity measure (the time offset for the pair be DAB=4, that is, signal B starts 4 time units after the start of signal A). Then, signal pair selection 613 (B, C) is also aligned and verified using prediction based similarity measure (the time offset for the pair be DBC=−1 or DCB=1, that is, signal C start 1 time unit before signal B). Based on these results, the common timeline is therefore such that signal A starts first, signal C starts 3 time units later than A, and signal B starts 4 time units later than A and 1 time unit later than C.

The operation of controlling the synchronisation of the signal pair and offset value on the common time line is shown in FIG. 4 by step 309.

In some embodiments, the similarity prediction value is determined even if the time offset from the time offset determiner is uncertain. For example in some embodiments the time offset determiner 203 can be configured to determine a time offset but may not sure whether the determined time offset value is the correct one or not. In this case the similarity predictor 205 (and verifier 207) can be configured to determine confirmation and verification of the proposed time offset.

In some embodiments, the similarity predictor 205 can be configured to receive one or more signals. For example in some embodiments where the original signal pair (x, y) did not produce ‘similar’ output the similarity predictor 205 can determine a similarity result for another signal pair (z, y) from the common timeline is chosen. In some embodiments the pairwise selection generates multiple signal pairs and at least some of the pre-defined number of pairs are more likely to produce ‘similar’ output results before the signal data pair is accepted for common timeline. For example the signal pair (S1=B, S2=C) fails to produce a ‘similar’ output result, but generated at the same time the signal pair (S1=A+1 time unit, S2=C) is tried also. A further example would be the pairwise selection of pairs (S1=B, S2=C) and (S1=A+1 time unit, S2=C), which are processed for similarity and the data pair (B, C) would get accepted to common timeline only if both data pairs produce ‘similar’ output result.

Furthermore in some embodiments, multiple similarity measures can be calculated for the signal data pair (x, y) and the final similarity measure is a combination of the values, for example the mean or median measure value. In these embodiments each signal in the signal pair can have multiple representation domains which are used to determine the similarity measure for the corresponding domain.

The foregoing description has provided by way of exemplary and non-limiting examples a full and informative description of the exemplary embodiment of this invention, However, various modifications and adaptations may become apparent to those skilled in the relevant arts in view of the foregoing description, when read in conjunction with the accompanying drawings.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention. In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate,

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1.-28. (canceled)

29. Apparatus comprising at least one processor and at least one memory including computer code for one or more programs, the at least one memory and the computer code configured to with the at least one processor cause the apparatus to:
receive an audio signal;
pairwise select the audio signal and a further audio signal, the further audio signal being a verified audio signal;
determine an audio signal time offset between the audio signal and the further audio signal;
generate a similarity index based on the time offset applied to one of the audio signal and the further audio signal when compared against the other of the audio signal and the further audio signal;
verify the audio signal time offset based on the similarity index; and
generate a common time line incorporating the audio signal.

30. The apparatus as claimed in claim 29, wherein the apparatus caused to verify the audio signal time offset based on the similarity index causes the apparatus to verify only a portion of the audio signal which overlaps with the further audio signal when the time offset is applied to at least one of audio signal and the further audio signal.

31. The apparatus as claimed in claim 29, wherein the apparatus caused to generate a common time line incorporating the audio signal causes the apparatus to incorporate only a portion of the audio signal which overlaps with the further audio signal when the time offset is applied to at least one of audio signal and the further audio signal.

32. The apparatus as claimed in claim 29, wherein the apparatus caused to generate a similarity index based on the time offset causes the apparatus to:
segment the audio signal into at least two sub-frames;
generate for the at least two sub-frames at least two predicted sub-frames based on the sub-frame audio signal and the audio signal time offset;
combine the predicted sub-frames; and
generate a similarity metric based on the combined predicted sub-frames and the further audio signal.

33. The apparatus as claimed in claim 32, wherein the apparatus caused to segment the audio signal into at least two sub-frames causes the apparatus to segment the audio signal into at least two overlapping sub-frames, and wherein the apparatus caused to combine the predicted sub-frames causes the apparatus to overlap-add the predicted sub-frames.

34. The apparatus as claimed in claim 32, wherein the apparatus caused to verify the audio signal time offset based on the similarity index causes the apparatus to:
compare the similarity metric against a similarity threshold range; and
verify at least a portion of the audio signal time offset where the similarity metric for the portion of the audio signal time offset is within the similarity threshold range.

35. The apparatus as claimed in claim 29, further caused to:
receive a second audio signal;
pairwise select the second audio signal and a second further audio signal, the second further audio signal being a verified audio signal;
determine a second audio signal time offset between the second audio signal and the second further audio signal;
generate a second similarity index based on the second time offset applied to one of the second audio signal and the second further audio signal when compared against the other of the second audio signal and the second further audio signal; and
determine that the second audio signal time offset based on the second similarity index is unverified.

36. The apparatus as claimed in claim 35, further caused to:
determine a further second audio signal time offset between the second audio signal and the second further audio signal; and
generate a further second similarity index based on the further second time offset applied to one of the second audio signal and the second further audio signal when compared against the other of the second audio signal and the second further audio signal.

37. The apparatus as claimed in claim 36, further caused to:
determine that the further second audio signal time offset based on the further second similarity index is unverified and further perform: at least one of:
repeating the determining of a further audio signal time offset;
repeating the pairwise selection; and
indicating the second audio signal is unverifiable.

38. The apparatus as claimed in claim 37, further caused to:
verify the further second audio signal time offset based on the similarity index; and
regenerate the common time line incorporating the second audio signal.

39. A method comprising:
receiving an audio signal;
pairwise selecting the audio signal and a further audio signal, the further audio signal being a verified audio signal;
determining an audio signal time offset between the audio signal and the further audio signal;
generating a similarity index based on the time offset applied to one of the audio signal and the further audio signal when compared against the other of the audio signal and the further audio signal;
verifying the audio signal time offset based on the similarity index; and
generating a common time line incorporating the audio signal.

40. The method as claimed in claim 39, wherein verifying the audio signal time offset based on the similarity index comprises verifying only a portion of the audio signal which overlaps with the further audio signal when the time offset is applied to at least one of audio signal and the further audio signal.

41. The method as claimed in claim 39, wherein generating a common time line incorporating the audio signal comprises incorporating only a portion of the audio signal which overlaps with the further audio signal when the time offset is applied to at least one of audio signal and the further audio signal.

42. The method as claimed in claim 39, wherein generating a similarity index based on the time offset comprises:
segmenting the audio signal into at least two sub-frames;
generating for the at least two sub-frames at least two predicted sub-frames based on the sub-frame audio signal and the audio signal time offset;
combining the predicted sub-frames; and
generating a similarity metric based on the combined predicted sub-frames and the further audio signal.

43. The method as claimed in claim 42, wherein segmenting the audio signal into at least two sub-frames comprises segmenting the audio signal into at least two overlapping sub-frames, and combining the predicted sub-frames comprises overlap-adding the predicted sub-frames.

44. The method as claimed in claim 42, wherein verifying the audio signal time offset based on the similarity index comprises:
comparing the similarity metric against a similarity threshold range; and
verifying at least a portion of the audio signal time offset where the similarity metric for the portion of the audio signal time offset is within the similarity threshold range.

45. The method as claimed in claim 39, further comprising:
receiving a second audio signal;
pairwise selecting the second audio signal and a second further audio signal, the second further audio signal being a verified audio signal;
determining a second audio signal time offset between the second audio signal and the second further audio signal;
generating a second similarity index based on the second time offset applied to one of the second audio signal and the second further audio signal when compared against the other of the second audio signal and the second further audio signal; and
determining that the second audio signal time offset based on the second similarity index is unverified.

46. The method as claimed in claim 45, further comprising:
determining a further second audio signal time offset between the second audio signal and the second further audio signal; and
generating a further second similarity index based on the further second time offset applied to one of the second audio signal and the second further audio signal when compared against the other of the second audio signal and the second further audio signal.

47. The method as claimed in claim 46, further comprising:
determining that the further second audio signal time offset based on the further second similarity index is unverified and further perform: at least one of:
repeating the determining of a further audio signal time offset;
repeating the pairwise selection; and
indicating the second audio signal is unverifiable.

48. The method as claimed in claim 47, further comprising:
verifying the further second audio signal time offset based on the similarity index; and
regenerating the common time line incorporating the second audio signal.
